(19) United States
(12) Patent Application Publication
(10) Pub. No.: US 2016/0149209 A1
(43) Pub. Date: May 26, 2016

(54) ELECTRODE COATED WITH INORGANIC LAYER, MANUFACTURING METHOD THEREOF AND RECHARGEABLE BATTERY THEREWITH

(71) Applicant: SAMSUNG SDI CO., LTD., Yongin-si (KR)

(72) Inventors: Bokkyu Jeon, Yongin-si (KR); Jonghwan Park, Yongin-si (KR); Junghyun Nam, Yongin-si (KR); Yeonjoo Choi, Yongin-si (KR); Aehui Goh, Yongin-si (KR)

(21) Appl. No.: 14/918,488

(22) Filed: Oct. 20, 2015

(30) Foreign Application Priority Data
Nov. 21, 2014 (KR) 10-2014-0163727

(51) Int. Cl. H01M 4/36; H01M 4/48; H01M 4/04; H01M 4/62

(52) U.S. Cl. CPC H01M 4/366; H01M 4/622; H01M 4/48; H01M 4/0404; H01M 2004/027

(57) ABSTRACT

An electrode coated with an inorganic layer having improved dispersibility and phase stability includes an electrode layer, and an inorganic layer coated on a surface of the electrode layer, wherein the inorganic layer includes inorganic particles and an organic acrylic-based binder. A manufacturing method of the electrode and a rechargeable battery including the electrode are also described.

### CROSS-REFERENCE TO RELATED APPLICATION

This application claims priority to and the benefit of Korean Patent Application No. 10-2014-0163727 filed on Nov. 21, 2014 in the Korean Intellectual Property Office, the contents of which in its entirety are herein incorporated by reference.

### BACKGROUND

1. Field

One or more aspects of embodiments of the present invention relate to an electrode coated with an inorganic layer, a manufacturing method thereof, and a rechargeable battery including the electrode.

2. Description of the Related Art

In general, a rechargeable battery can be repeatedly charged and discharged, unlike a primary battery is not designed be recharged. A low-capacity rechargeable battery is typically used for small portable electronic devices such as a smart phone, a tablet computer, or a digital camera. A large-capacity rechargeable battery, which can be obtained by connecting several tens of battery cells in a pack shape, is widely used as a power supply for driving a motor of an electric bicycle, an electric scooter, a hybrid vehicle, an electric vehicle, and/or the like.

Rechargeable secondary batteries can be manufactured in various shapes, for example, a prismatic shape, a cylindrical shape, and/or a pouch shape. A rechargeable battery typically includes an electrode assembly in which a positive electrode and a negative electrode, with a separator interposed between the positive and negative electrodes as an insulator, are placed in a case accommodating the electrode assembly and an electrolyte solution.

### SUMMARY

One or more embodiments of the present invention provide an electrode coated with an inorganic layer having improved dispersibility and phase stability, a manufacturing method thereof, and a rechargeable battery including the electrode.

The above and other aspects of the present invention will be described in or be apparent from the following description of the example embodiments.

According to some embodiments of the present invention, an electrode includes an electrode layer and an inorganic layer on a surface of the electrode layer, the inorganic layer including inorganic particles and an organic acrylic-based binder.

The organic acrylic-based binder may have an acrylate-acrylic acid-acrylonitrile structure.

The acrylate may be selected from alkyl acrylates with carbon numbers of the alkyl group in the range of C1 to C6, such as methyl acrylate, ethyl acrylate, propyl acrylate, butyl acrylate, and hexyl acrylate, and mixtures of two or more thereof.

In addition, the acrylate may be selected from alkyl acrylates with carbon numbers of the alkyl group in the range of C7 to C12, such as octyl acrylate, dodecyl acrylate, and heptyl acrylate, and mixtures of two or more thereof.

The organic acrylic-based binder may have a crosslinking structure.

The electrode may further include a crosslinking agent, and the crosslinking agent may be selected from epoxy, trimethylolpropane, pentaerythritol and mixtures of two or more thereof.

The electrode may be a negative electrode.

The inorganic particles may be selected from the group consisting of BaTiO₃, Pb(Zr,Ti)O₃(PZT), Pb₁₋ₓLaₓZr_{1-y}Ti_{y}O₃(PLZT) (where 0<x<1 and 0<y<1), PB(Mg₃Nb2/3)O₃—PbTiO₃(PMN—PT), hafnia (HfO₂), SrTiO₃, SnO₂, CeO₂, MgO, NiO, CaO, ZnO, ZrO₂, SiO₂, Y₂O₃, Al₂O₃, SiC, TiO₂, and mixtures of two or more thereof.

According to some embodiments of the present invention, there is provided a manufacturing method of an electrode coated with an inorganic layer, the manufacturing method including preparing an organic acrylic-based binder solution; preparing an inorganic slurry by mixing inorganic particles with the organic acrylic-based binder solution and dispersing; and coating and drying the inorganic slurry on a surface of an electrode layer.

The organic acrylic-based binder solution may be prepared by a method including a solution polymerization method.

The volume-cumulative (50%) particle size (D50) of inorganic particles in the inorganic slurry calculated based on a laser diffraction scattering diameter distribution method may be from 0.8 μm to 2.5 μm, and a ratio of the volume-cumulative (90%) particle size (D90) to the volume-cumulative (10%) particle size (D10) (D90/D10) may be in a range of 7 to 13.

According to some embodiments of the present invention, there is provided a rechargeable battery including the electrode.

Embodiments of the present invention provide an electrode coated with an inorganic layer having improved dispersibility and phase stability, a manufacturing method thereof, and a rechargeable battery including the electrode. In some embodiments, an inorganic slurry is prepared by mixing inorganic particles with various kinds (or types) of organic acrylic-based binders prepared by a solution polymerization method and dispersing. Thus prepared inorganic slurry may have better dispersibility and phase stability than a typical inorganic slurry. Accordingly, when an electrode is coated with the inorganic slurry according to embodiments of the present invention to form an inorganic layer, battery characteristics may be improved.

In some embodiments, the volume-cumulative (50%) particle size (D50) of inorganic particles in the inorganic slurry (calculated based on laser diffraction scattering measurement of the particle size distribution) is about 0.8 μm to about 2.5 μm, and a ratio of the volume-cumulative (90%) particle size (D90) to the volume-cumulative (10%) particle size (D10) (D90/D10) is in a range of about 7 to about 13. Accordingly, the inorganic particles may demonstrate a narrow particle size distribution (exhibit a sharp particle distribution and a uniform particle diameter distribution) and a small extent of agglomeration, thus resulting in excellent dispersibility and phase stability. Therefore, the electrode having an inorganic layer prepared from the inorganic slurry of embodiments of the present invention and the rechargeable battery including the electrode may have improved characteristics.

### BRIEF DESCRIPTION OF THE DRAWINGS

The above and other features and aspects of the present invention will become more apparent from the description of embodiments thereof with reference to the attached drawings in which:

FIG. 1 is a cross-sectional view of an electrode coated with an inorganic layer according to some embodiments of the present invention;

FIG. 2 is a flowchart illustrating a manufacturing method of an electrode coated with an inorganic layer according to some embodiments of the present invention;

FIG. 3 is a cross-sectional view of a rechargeable battery including an electrode coated with an inorganic layer according to some embodiments of the present invention; and

FIGS. 4A and 4B are graphs illustrating results of improved dispersibility of inorganic particles in inorganic slurries according to Examples of the present invention.

### DETAILED DESCRIPTION

Hereinafter, some example embodiments are described in further detail with reference to the accompanying drawings.

However, the present invention may be embodied in different forms and should not be construed as limited to the embodiments set forth herein. Rather, these embodiments are provided so that this disclosure will be thorough and complete, and will fully convey embodiments of the invention to those skilled in the art.

In the drawings, thicknesses of layers and regions may be exaggerated for clarity. Like numbers refer to like elements throughout. As used herein, the term “and/or” includes any and all combinations of one or more of the associated listed items. Expressions such as “at least one of” and “one of,” when preceding a list of elements, modify the entire list of elements and do not modify the individual elements of the list. Further, the use of “may” when describing embodiments of the present invention refers to “one or more embodiments of the present invention.”

The terminology used herein is for the purpose of describing particular embodiments and is not intended to be limiting of the invention. As used herein, singular forms are intended to include the plural forms as well, unless the context clearly indicates otherwise. It will be further understood that the terms, such as “comprises,” “comprising,” “includes”, and/or “including”, when used in this specification, specify the presence of stated features, integers, steps, operations, elements, and/or components, but do not preclude the presence or addition of one or more other features, integers, steps, operations, elements, components, and/or groups thereof.

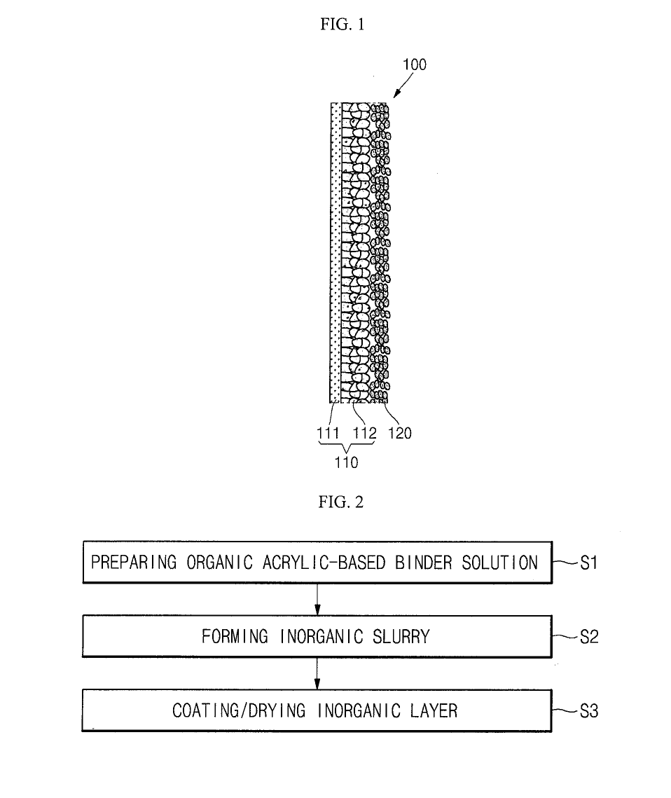

Referring to FIG. 1, a cross-sectional view of an electrode coated with an inorganic layer according to an embodiment of the present invention is illustrated.

As illustrated in FIG. 1, the electrode 100 according to some embodiments of the present invention includes an electrode layer 110 and an inorganic layer 120 coated on a surface of the electrode layer 110 to have a predetermined (or set) thickness.

The electrode layer 110 may include, for example, a current collecting layer 111 and an electrode active material layer 112 on a surface of the current collecting layer 111. The electrode layer 110 may be, for example, a negative electrode, but aspects of the present invention are not limited thereto. Alternatively, the electrode layer 110 may be, for example, a positive electrode. In FIG. 1, a negative electrode is illustrated as an example.

In the negative electrode layer 110, a negative electrode current collecting layer 111 may be a foil or a mesh made from, for example, copper, gold, nickel, a copper alloy, or a combination thereof, but aspects of the present invention are not limited thereto.

In a case of a positive electrode layer, a positive electrode current collecting layer may be a foil or a mesh made from, for example, aluminum, nickel, or a combination thereof, but aspects of the present invention are not limited thereto.

In the negative electrode layer 110, a negative electrode active material layer 112 may include a lithium intercalation material such as, for example, carbon, petroleum coke, activated carbon, graphite, lithium metal, a lithium alloy, or a combination thereof, but aspects of the present invention are not limited thereto. Alternatively, any negative electrode active material suitable for use in a negative electrode of a typical rechargeable battery can be used.

In the positive electrode layer, a positive electrode active material layer may include a lithium intercalation material such as, for example, lithium manganese oxide, lithium cobalt oxide, lithium nickel oxide, lithium iron oxide, or a composite oxide formed by combining any of these oxides, but aspects of the present invention are not limited thereto. Alternatively, any positive electrode active material suitable for use in a positive electrode of a typical rechargeable battery can be used.

The inorganic layer 120 may include a plurality of inorganic particles and an organic acrylic-based binder. In addition, the inorganic layer 120 may further include a crosslinking agent and/or other additives.

Any suitable inorganic particles known to those of skill in the art may be used as the inorganic particles. In some embodiments, empty spaces exist between the inorganic particles that serve as major components for forming the inorganic layer 120, thus creating micropores. In addition, the inorganic particles may serve as spacers capable of physically supporting the inorganic layer 120.

The inorganic particles included in the inorganic layer 120 are not specifically limited so long as they are electrochemically stable. In other words, the inorganic particles according to embodiments of the present invention are not specifically limited so long as an oxidation and/or a reduction reaction do not occur at an operating voltage of a battery that is employed in a reaction. In some embodiments, inorganic particles having ion transfer capability can be used. In this case, ion conductivity in a rechargeable battery can be increased, thereby further improving battery performance.

In some embodiments, the inorganic particles may be selected from BaTiO₃, Pb(Zr,Ti)O₃(PZT), Pb₁₋ₓLaₓZr_{1-y}Ti_{y}O₃(PLZT) (where 0<x<1 and 0<y<1), PB(Mg₃Nb2/3)O₃—PbTiO₃(PMN—PT), hafnia (HfO₂), SrTiO₃, SnO₂, CeO₂, MgO, NiO, CaO, ZnO, ZrO₂, SiO₂, Y₂O₃, Al₂O₃, SiC, TiO₂, and/or mixtures of two or more of these materials. Since the inorganic particles have a relatively high dielectric constant, a degree of dissociation of an electrolyte salt in a liquid electrolyte, for example, a lithium salt, increases, and ion conductivity of the electrolyte solution is improved accordingly.

In some embodiments, the inorganic particles may be selected from (LiAlTiP)ₓO_{y} series glass (0<x<4, 0<y<13), such as lithium phosphate(Li₃PO₄), lithium titanium phosphate (LiₓTi_{y}(PO₄)₃, 0<x<2, 0<y<3), lithium aluminum titanium phosphate (LiₓAl_{y}Ti_{z}(PO₄)₃, 0<x<2, 0<y<1, 0<z<3) or 14Li₂O-9Al₂O₃-38TiO₂-39P₂O₅; lithium lanthanum titanate (LiₓLa_{y}TiO₃, 0<x<2, 0<y<3); lithium germanium thiophosphate (LiₓGe_{y}P_{z}S_{w}, 0<x<4, 0<y<1, 0<z<1, 0<w<5), such as Li_{3.25}Ge_{0.25}P_{0.75}S₄; lithium nitride (LiₓN_{y}, 0<x<4, 0<y<2), such as Li₃N; SiS₂ series glass (e.g., LiₓSi_{y}S_{z}, 0<x<3, 0<y<2, 0<z<4), such as Li₃PO₄-Li₂S—SiS₂; P₂S₅ series glass (e.g., LiₓP_{y}S_{z}, 0<x<3, 0<y<3, 0<z<7), such as LiI—-Li₂S—P₂S₅; and/or mixtures of two or more of these materials. The inorganic particles may transfer and move lithium ions due to defects formed therein, thereby improving ion conductivity of battery.

When the inorganic particles having a high dielectric constant and the inorganic particles having lithium ion transfer capability are used in combination, the effects of each can be further increased.

In addition, sizes of the inorganic particles are not specifically limited.

However, in order to form the inorganic layer 120 having a uniform thickness and to provide the binder with an appropriate viscosity, the inorganic particles may have sizes in a range of about 0.01 μm about 10 μm, for example, in a range of about 0.1 μm to about 2 μm, or in a range of about 0.5 μm to about 1.5 μm. If the sizes of the inorganic particles are less than about 0.01 μm, the dispersibility and phase stability may decrease and agglomeration of the inorganic particles may increase, thereby making it more difficult to control the physical properties of the inorganic layer 120. If the sizes of the inorganic particles are greater than about 10 μm, the thickness of the inorganic layer 120 may increase, thus lowering mechanical properties of the inorganic layer 120. In addition, internal short circuits may be more likely to occur during charging/discharging of a rechargeable battery due to excessively large-sized pores.

In some embodiments, the organic acrylic-based binder has an acrylate-acrylic acid-acrylonitrile structure.

For example, the acrylate may be selected from alkyl acrylates with carbon numbers of the alkyl group in the range of C1 to C6, such as methyl acrylate, ethyl acrylate, propyl acrylate, butyl acrylate, and hexyl acrylate, and mixtures of two or more of these materials.

In some embodiments, the acrylate may be selected from alkyl acrylates with carbon numbers of the alkyl group in the range of C7 to C12, such as octyl acrylate, dodecyl acrylate, and heptyl acrylate, and mixtures of two or more of these materials.

In some embodiments, the organic acrylic-based binder may have a linear structure that is not crosslinked.

Alternatively, the organic acrylic-based binder may have a crosslinking structure.

For example, the organic acrylic-based binder may be a crosslinked hydrophobic acrylic-based binder.

Here, the organic acrylic-based binder may be adjusted to have a degree of crosslinking of about 1% to about 20%. Practically, if the degree of crosslinking of the organic acrylic-based binder is smaller than 1%, the organic acrylic-based binder may elute (or permeate) into an electrolyte solution. If the degree of crosslinking of the organic acrylic-based binder is greater than 20%, the viscosity becomes increased, making it difficult to perform agitation. The degree of crosslinking may be adjusted by adjusting the amount of the crosslinking agent, which will be described later.

The crosslinking agent may be selected from epoxy, trimethylolpropane, pentaerythritol, and/or mixtures of two or more of these materials, but aspects of the present invention are not limited thereto.

The organic acrylic-based binder may allow for small-sized inorganic particles to be dispersed (e.g., substantially evenly or well dispersed), without being agglomerated with one another, and may improve the adherence of the inorganic layer 120 to the electrode layer 110. To further improve the adherence of the inorganic layer 120 to the electrode layer 110, specifically to the negative electrode layer 110, an organic acrylic polymer resin binder, rather than a waterborne binder, may be used in embodiments of the present invention. When the inorganic layer 120 is coated on the negative electrode layer 110 using a waterborne binder, the negative electrode active material layer 112 may be stripped.

In the inorganic layer 120 coated on the electrode layer 110 according to embodiments of the present invention, a composition ratio of the inorganic particles to the organic acrylic-based binder is not specifically limited, but may be in a range of about 70:30 to about 99:1, for example, in a range of about 80:20 to about 90:10, or in a range of about 94:6 to about 99:1. If the content of the inorganic particles is less than about 70 parts by weight, the content of the organic acrylic-based binder may be excessively large, so that pore sizes and porosity may be reduced due to a reduction in the number of empty spaces created between the inorganic particles, thus resulting in deterioration of battery performance. If the content of the inorganic particles is greater than about 99 parts by weight, the content of the organic acrylic-based binder is so small that cohesive forces among the inorganic particles may be weakened, thus lowering mechanical properties of the inorganic layer 120.

In some embodiments, in the inorganic layer 120 coated on the electrode layer 110, a thickness of the inorganic layer 120 is not specifically limited, but may be in a range of about 0.1 μm to about 20 μm, for example, in a range of about 0.5 μm to about 10 μm, or in a range of about 1 μm to about 5 μm, depending on the desired battery performance. If the thickness of the inorganic layer 120 is smaller than 0.1 μm, an internal short circuit may be more likely to occur between positive and negative electrodes. If the thickness of the inorganic layer 120 is greater than 20 μm, the inorganic layer 120 may function as a resistive layer.

The inorganic layer 120 is not specifically limited in view of pore size and porosity, but may have a pore size in a range of about 0.001 μm to about 10 μm and a porosity in a range of about 5% to about 95%. If the pore size and/or porosity are less than about 0.001 μm and/or about 5%, the inorganic layer 120 may function as a resistive layer. If the pore size and/or porosity are greater than about 10 μm and/or about 95%, it may be difficult to maintain the desired mechanical properties of the inorganic layer 120.

As described above, excellent dispersibility and phase stability of the inorganic particles can be maintained for an extended period of time (e.g., three days or so) by the organic acrylic-based binder. In addition, cohesive forces among the inorganic particles and/or an adhesive force between each of the inorganic particles and an electrode layer can be improved by the organic acrylic-based binder.

Referring to FIG. 2, a flowchart of a manufacturing method of an electrode coated with an inorganic layer according to some embodiments of the present invention is illustrated.

As illustrated in FIG. 2, the manufacturing method of the electrode according to some embodiments of the present invention includes preparing an organic acrylic-based binder solution (S1), preparing an inorganic slurry (S2), and coating/drying an inorganic layer (S3).

In the preparing of the organic acrylic-based binder solution (S1), the organic acrylic-based binder solution is prepared by dissolving a mixture of acrylate-acrylic acid-acrylonitrile in a solvent. Here, the solvent may include, for example, N-methylpyrrolidone, methanol, ethanol, chloroform, dichloromethane, ethylacetate, hexane; and/or mixtures thereof, but aspects of the present invention are not limited thereto.

In addition, if the organic acrylic-based binder has a crosslinking structure, a crosslinking agent may further be added to the organic acrylic-based binder solution.

In some embodiments, the organic acrylic-based binder may have a viscosity in a range of about 100 cps to about 10,000 cps, for example, in a range of about 500 cps to about 5,000 cps, or in a range of about 1,000 cps to about 2,000 cps. If the viscosity of the organic acrylic-based binder is smaller than 100 cps, the inorganic slurry may flow too easily during coating of the inorganic slurry, and may permeate an unwanted area. If the viscosity of the organic acrylic-based binder is greater than 10,000 cps, agitation and handling of the inorganic slurry become difficult to achieve.

In some embodiments, the organic acrylic-based binder solution may be prepared by dissolving the monomers (e.g., acrylate, acrylic acid, and acrylonitrile) in a low-viscosity, easily agitatable solvent of the reaction system and polymerizing the resultant product using one or more of suitable solution polymerization methods.

In the preparing of the inorganic slurry (S2), the inorganic particles are mixed with the prepared organic acrylic-based binder solution to then be dispersed, thereby preparing the inorganic slurry.

After the mixing of the inorganic particles with the organic acrylic-based binder solution, pulverizing of the inorganic particles may further be performed. A suitable pulverizing time may be in a range of about 1 to about 20 hours, and particle diameters of pulverized inorganic particles may be in a range of about 0.001 μm to about 10 μm, as described above.

As the pulverizing method, any suitable method known to those of skill in the art may be used. In some embodiments, a ball mill and/or beads mill method may be used as the pulverizing method.

A composition of the inorganic slurry, including the inorganic particles and the organic acrylic-based binder solution, is not specifically limited. For example, the thickness, pore size and porosity of a finally formed inorganic layer may be adjusted according to the composition of the inorganic slurry.

In some embodiments, powder-type inorganic particles may be pre-pulverized to the aforementioned particle size to then be mixed with the organic acrylic-based binder solution and dispersed. The mixing of the powder-type inorganic particles and the organic acrylic-based binder solution may be performed by a mixer comprised of a planetary and a disperser, and a mixing time may be in a range of about 1 to about 20 hours.

In the coating/drying of the inorganic layer (S3), the inorganic slurry, including the inorganic particles and the organic acrylic-based binder solution, is coated on an electrode layer and dried, thereby forming an inorganic layer having a constant (or substantially constant) thickness on the electrode layer.

Any suitable coating method known to those skilled in the art may be used as the coating method of the inorganic slurry, and non-limiting examples thereof may include deep coating, spin coating, roll coating, meyer bar coating, comma coating, die coating, gravure coating, screen printing, offset printing, brush painting, spraying, combinations thereof, and/or the like. In addition, the inorganic layer may be formed on both surfaces of an electrode (opposite from each other) or only on one surface of the electrode, and may be formed on a negative electrode, a positive electrode, or on both the negative electrode and the positive electrode.

The electrode coated with the inorganic layer according to embodiments of the present invention may be used as an electrode of a secondary battery, for example, a lithium ion secondary battery. In embodiments where a gellable polymer is used as a binder for an inorganic layer during impregnation of an electrolyte solution, the electrolyte solution and the polymer may react with each other after the battery is assembled, thus resulting in gelation.

In the aforementioned embodiments, the preparing of the organic acrylic-based binder solution (S1) and the preparing of the inorganic slurry (S2) are performed independently. However, for purposes of reducing the manufacturing time and saving the manufacturing cost, the two steps may be performed in combination. In other words, monomers of acrylate, acrylic acid and acrylonitrile, a solvent, and powder-type inorganic particles may be separately transferred to an agitation vessel and the mixture may be stirred using stirring blades, thereby preparing the inorganic slurry. During the agitating, supplying vacuum to the agitation vessel, may eliminate or reduce the need for additional degassing.

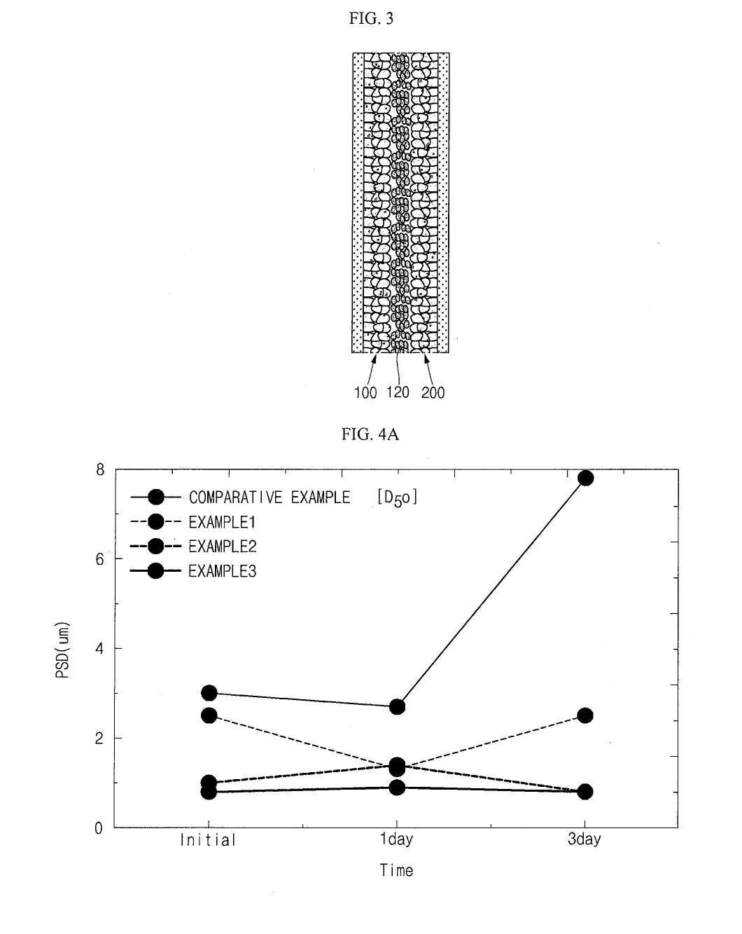

Referring to FIG. 3, a cross-sectional view of a rechargeable battery including an electrode coated with an inorganic layer according to some embodiments of the present invention is illustrated.

As illustrated in FIG. 3, similar to the rechargeable battery described above, the rechargeable battery according to an embodiment of the present invention includes an electrode (e.g., a negative electrode) 100 coated with an inorganic layer 120 on an electrode layer, and another electrode (e.g., a positive electrode) 200 contacting the inorganic layer 120. An electrolyte solution is interposed between the positive and negative electrodes. The inorganic layer 120 may also serve as a separator between the positive and negative electrodes. In some cases, however, an additional separator may further be interposed between the positive and negative electrodes.

### Preparation of Inorganic Slurry

### EXAMPLE 1

A mixture of 35 parts by weight of ethyl acrylate and 35 parts by weight of butyl acrylate (selected from alkyl acrylates with carbon numbers of the alkyl group in the range of C1 to C6), 15 parts by weight of acrylic acid and 15 parts by weight of acrylonitrile, was added to N-methylpyrrolidone and then dissolved at 50° C. for more than 12 hours to prepare an organic acrylic-based binder polymer solution. Here, the content of the mixture was adjusted to 9 parts by weight based on 91 parts by weight of N-methylpyrrolidone.

To the prepared polymer solution, Al₂O₃ powder was added as inorganic particles to prepare a mixture including the polymer solution and the inorganic particles in a weight ratio of 70:30, followed by pulverizing the Al₂O₃ powder using a ball mill for more than 3 hours and dispersing, thereby preparing the inorganic slurry.

The particle diameter of the Al₂O₃ powder of the prepared inorganic slurry can be controlled by controlling the bead sizes (particle sizes) used in the ball mill and the ball milling time. In Example 1, the pulverizing was performed to have a particle size in a range of about 0.5 μm to about 1.5 μm to prepare the inorganic slurry.

### EXAMPLE 2

The inorganic slurry was prepared in the same or substantially the same manner as in Example 1, except that 0.5 parts by weight of epoxy was additionally used as a crosslinking agent. Here, the extent of crosslinking of the inorganic slurry was adjusted to be about 10% by controlling an amount of the crosslinking agent.

### EXAMPLE 3

The inorganic slurry was prepared in the same or substantially the same manner as in Example 2, except that 70 parts by weight of dodecyl acrylate was used (selected from alkyl acrylates with carbon numbers of the alkyl group in the range of C7 to C12) instead of a combination of ethyl acrylate and butyl acrylate.

### COMPARATIVE EXAMPLE

The inorganic slurry was prepared in the same or substantially the same manner as in Example 1, except that an acrylic binder polymer solution was prepared by dissolving a mixture of 85 parts by weight of butylacrylate and 15 parts by weight of acrylonitrile in N-methylpyrrolidone as a solvent at 50° C. for more than 12 hours. The compositions and respective characteristics of the inorganic slurries are summarized in Table 1 below.

TABLE 1

| | Comparative | | | |
|---|---|---|---|---|
| | Example | | | |
| | (Commonly used | | | |
| Binder | binder) | Example 1 | Example 2 | Example 3 |
| Structure | BA-AN | acrylate-AA-AN | acrylate-AA-AN | acrylate-AA-AN |
| Feature | Crosslinked/ | Linear/ | Crosslinked/ | Hydrophobic |
| | Degree of | Degree of | Degree of | Acrylic-based/ |
| | Crosslinking | Crosslinking | Crosslinking | Degree of |
| | (approximately | (0%) | (10%) | Crosslinking |
| | 80%) | | | (10%) |

| Nonvolatile (NV | 9 | 30 |
|---|---|---|
| %) | | |
| Solvent | N-methylpyrrolidone | |
| Viscosity (cps) | 700 | 1,000~2,000 |
| Polymerization | Emulsion | Solution |
| Type | | |

Here, NV % indicates a ratio of a solids content in a solution, and the solids content means the content of the inorganic particles and the binder, excluding the solvent volatilized through the drying after coating the slurry.

### Analysis of Dispersibility of Inorganic Layers

Before forming the inorganic layer on the electrode layer, in order to test dispersibility and phase stability of the inorganic slurry, an initial dispersity of the inorganic slurry, dispersity one day after forming the inorganic layer (i.e., after the inorganic layer was left alone for one day) and dispersity three days after forming the inorganic layer (i.e., after the inorganic layer was left alone for three days), were measured. Here, the dispersity measurement may be performed based on laser diffraction scattering diameter distribution method, but aspects of the present invention are not limited thereto.

Table 2 shows dispersity values (particle size distribution (μm)) of inorganic particles in inorganic slurries according to Examples 1 to 3 and Comparative Example.

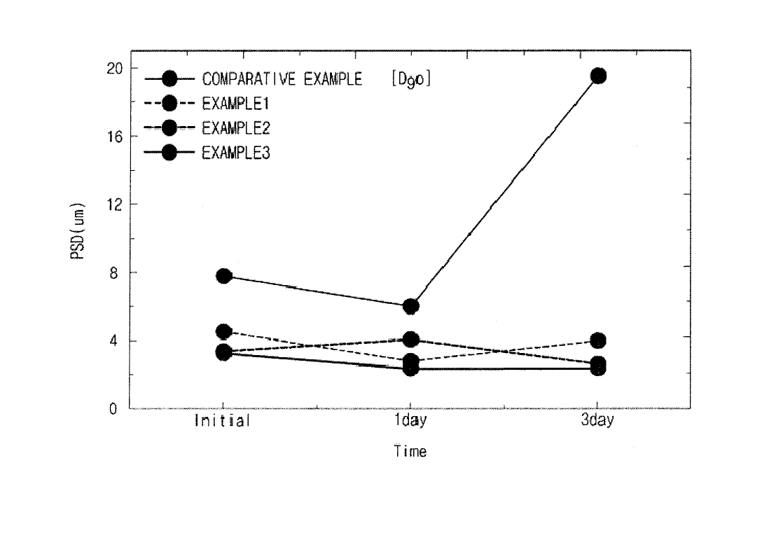

In addition, FIGS. 4A and 4B are graphs illustrating dispersibility values of inorganic particles in inorganic slurries according to Examples of the present invention. In FIGS. 4A and 4B, the X-axis indicates the time (in days), and the Y-axis indicates the dispersity (particle-size distribution PSD) (μm).

Dispersity values of the volume-cumulative (10%) particle size (D10), the volume-cumulative (50%) particle size (D50), and the volume-cumulative (90%) particle size (D90) are listed in Table 2. In addition, the graphical representation of the dispersity of the volume-cumulative (50%) particle size (D50) is illustrated in FIG. 4A, and the graphical representation of the dispersity of the volume-cumulative (90%) particle size (D90) is illustrated in FIG. 4B.

Herein, the volume-cumulative (10%) particle size (D10), as measured based on the laser diffraction scattering diameter distribution method, may refer to a diameter of particles when the cumulative volume of the particles reaches 10 volume % in a particle distribution, the volume-cumulative (50%) particle size (D50) may refer to a diameter of particles when the cumulative volume of the particles reaches 50 volume % in a particle distribution, and the volume-cumulative (90%) particle size (D90) may refer to a diameter of particles when the cumulative volume of the particles reaches 90 volume % in a particle distribution, in ascending order on the basis of mass, among particle diameters measured by a laser diffraction scattering diameter distribution measuring device.

In general, the volume-cumulative (50%) particle size (D50) may correspond to an average particle diameter. In Examples 1 to 3, the volume-cumulative (50%) particle size (D50) was measured to be from 0.8 μm to 2.5 μm over an extended period of time (from the initial time to 3 days being left alone after forming the inorganic layer), thus confirming that the average particle diameter was small and the inorganic slurry demonstrated excellent dispersibility. In contrast, in Comparative Example, the volume-cumulative (50%) particle size (D50) was measured to be from 2.7 μm to 7.8 μm during an extended period of time (from the initial time to 3 days being left alone after forming the inorganic layer), thus showing that the average particle diameter was considerably large and the dispersibility was relatively poor. In other words, in Comparative Example, the inorganic particles in the inorganic layer exhibited a considerable extent of agglomeration.

A ratio of the volume-cumulative (90%) particle size (D90) to the volume-cumulative (10%) particle size (D10) (D90/D10), each measured based on a laser diffraction scattering diameter distribution method during an extended period of time (from the initial time to 3 days being left alone after forming the inorganic layer), was 13 or less, specifically in a range of 7 to 13.

The ratio (D90/D10), when it is a relatively small value, is an index showing a narrow particle size distribution (a sharp particle distribution and a uniform particle diameter distribution). Therefore, when the ratio (D90/D10) is 13 or less, specifically in a range of 7 to 13, the inorganic particles of the inorganic slurry according to embodiments of the present invention have a narrow particle size distribution, and demonstrate a small extent of agglomeration and excellent dispersibility and phase stability.

In Comparative Example, the ratio (D90/D10) measured during an extended period of time (from the initial time to 3 days being left alone after forming the inorganic layer), was 5 to 7. However, since the volume-cumulative (10%) particle size (D10) and the volume-cumulative (90%) particle size (D90) were relatively large values, the ratio (D90/D10) cannot be the basis for concluding that the dispersibility and phase stability of inorganic particles were good. Therefore, in Comparative Example, the volume-cumulative (50%) particle size (D50) of the inorganic particles in the inorganic slurry was used for evaluation, and this value, which was measured based on the slurry based on the laser diffraction scattering diameter distribution method, was 2.7 μm to 7.8 μm—higher than the volume-cumulative (50%) particle size (D50) in Examples 1 through 3.

TABLE 2

| | Slurry Stability (D10/D50/D90, μm) | | |
|---|---|---|---|
| Dispersity | Initial | After 1 day | After 3 days |
| Comparative | 1.0/3.0/7.8 | 1.1/2.7/6.0 | 2.7/7.8/19.5 |
| Example 1 | 0.4/2.5/4.5 | 0.4/1.3/2.8 | 0.3/0.8/4.0 |
| Example 2 | 0.4/1.0/3.4 | 0.4/1.4/4.1 | 0.3/0.8/2.6 |
| Example 3 | 0.4/0.8/3.3 | 0.4/0.9/2.4 | 0.3/0.8/2.4 |

While the electrode coated with an inorganic layer, the manufacturing method thereof, and the rechargeable battery including the electrode according to embodiments of the present invention have been shown and described with reference to exemplary embodiments thereof, it will be understood by those of ordinary skill in the art that various changes in form and details may be made therein without departing from the spirit and scope of the present invention as defined by the following claims and equivalents thereof. Therefore, the present embodiments should be considered in all respects as illustrative and not restrictive, where the appended claims and equivalents thereof, rather than the foregoing description, define the scope of the invention.

What is claimed is:

1. An electrode comprising:
an electrode layer; and
an inorganic layer on a surface of the electrode layer,
the inorganic layer comprising inorganic particles and an organic acrylic-based binder.

2. The electrode of claim 1, wherein the organic acrylic-based binder has an acrylate-acrylic acid-acrylonitrile structure.

3. The electrode of claim 2, wherein the acrylate is selected from the group consisting of alkyl acrylates with carbon numbers of the alkyl group in the range of C1 to C6 comprising methyl acrylate, ethyl acrylate, propyl acrylate, butyl acrylate, and hexyl acrylate, and mixtures of two or more thereof.

4. The electrode of claim 2, wherein the acrylate is selected from the group consisting of alkyl acrylates with carbon numbers of the alkyl group in the range of C7 to C12 comprising octyl acrylate, dodecyl acrylate, and heptyl acrylate, and mixtures of two or more thereof.

5. The electrode of claim 1, wherein the organic acrylic-based binder has a crosslinking structure.

6. The electrode of claim 1, further comprising a crosslinking agent, the crosslinking agent being selected from the group consisting of epoxy, trimethylolpropane, pentaerythritol, and mixtures of two or more thereof.

7. The electrode of claim 1, wherein the electrode is a negative electrode.

8. The electrode of claim 1, wherein the inorganic particles are selected from the group consisting of BaTiO₃, Pb(Zr,Ti)O₃(PZT), Pb₁₋ₓLaₓZr_{1-y}Ti_{y}O₃(PLZT) (wherein 0<x<1 and 0<y<1), PB(Mg₃Nb2/3)O₃—PbTiO₃(PMN—PT), hafnia (HfO₂), SrTiO₃, SnO₂, CeO₂, MgO, NiO, CaO, ZnO, ZrO₂, SiO₂, Y₂O₃, Al₂O₃, SiC, TiO₂ and mixtures of two or more thereof.

9. A manufacturing method of an electrode coated with an inorganic layer, the manufacturing method comprising:
preparing an organic acrylic-based binder solution;
preparing an inorganic slurry by mixing inorganic particles with the organic acrylic-based binder solution and dispersing; and
coating and drying the inorganic slurry on a surface of an electrode layer.

10. The manufacturing method of claim 9, wherein the organic acrylic-based binder solution is prepared by a method comprising a solution polymerization method.

11. The manufacturing method of claim 9, wherein the volume-cumulative (50%) particle size (D50) of inorganic particles in the inorganic slurry calculated based on a laser diffraction scattering diameter distribution method is 0.8 μm to 2.5 μm, and a ratio of the volume-cumulative (90%) particle size (D90) to the volume-cumulative (10%) particle size (D10) (D90/D10) is in a range of 7 to 13.

12. A rechargeable battery comprising the electrode of claim 1.
